(19) United States
(12) Patent Application Publication
(10) Pub. No.: US 2007/0272163 A1
(43) Pub. Date: Nov. 29, 2007

(54) Pet food/water bowl with splash guard/retention wall to protect surrounding walls and floor from over spray, splatters and splashes of feed or water

(76) Inventor: Amy A. Leary, Melbourne, FL (US)

Correspondence Address: AMY A. LEARY, 3628 LONG LEAF DRIVE, MELBOURNE, FL, 32940, US

(21) Appl. No.: 11/517,494

(22) Filed: Sep. 7, 2006

Related U.S. Application Data
(60) Provisional application No. 60/808,229, filed on May 25, 2006.

(51) Int. Cl. A01K 5/01

(52) U.S. Cl. 119/61.54

(57) ABSTRACT

A pet feeding bowl with an attached splashguard that acts as a retention barrier to protect walls, floors and other adjacent surfaces from over spray, splashes, and splatters that occur when a pet feeds from the bowl. The bowl has a round bowl as the base. The base area serves as the feeding bowl. The splashguard is an elevated section, from the perimeter of the top of the base bowl, whereas the apex of the bowl is at the rear of the bowl and tapering down in height to the front of the bowl.

### CROSS-REFERENCE TO RELATED APPLICATIONS

This application claims the benefits of U.S. Provisional Patent Application No. 60/808,229, filed May 25, 2006.

### FIELD OF THE INVENTION

The present invention relates particularly to a feeding bowl for household pets and in particular to a splash guard to contain over spray, splashes and splatters occurring from the pets feeding actions, to the confines of the bowl. The splash guard, which is elevated above the top perimeter of the bowl portion of the unit, has a gradual decline in height around the perimeter, towards the front of the bowl for ample success in its purpose of protecting walls, cabinets, trim, floors, etc. from mold, mildew and/or damage caused by the over spray, splashes or splatters of pet food and/or water.

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

A common occurrence is excessive damage to walls and/or floors adjacent to a pets eating dish(es) and feeding area. Especially dominant in medium to large breed dogs, is the occurrence of over splashing, splattering and over spray of water or food during the feeding process. The residue from over spray, splashes or splatters often results in damage to walls, trim, cabinets and flooring and also can become a breeding ground for molds and mildew.

This invention addresses these dilemmas by: 1.) having the attached back and sidewall act as a splashguard, this forces the over spray, splashes and splatters to remain in the confines of the bowl. 2.) having the gradual decline in the height of the splashguard portion leveling out to smaller guard as a small section of the front of the bowl to act as a guide for the pets placement of its face when feeding. 3.) having the disbursement of the weight of the bowl and design of the bowl to prevent tipping of the bowl during feeding. 4.) having the design of the bowl to allow for feeding of small, medium, large and extras large breeds. A small breed animal may use the same bowl as a larger breed animal. 5.) having the rim on the inside of the bowl act as a “fill to” level for optimal results with the bowl.

### SUMMARY OF THE INVENTION

A food or water bowl for household pets, which serves to provide food and/or water while protecting surrounding areas from over spray, splashes and splatters that occurs when the animal is feeding.

The present invention comprises a round shape base having a splash guard elevated from the top circumference of bowl with the highest point in the rear of the bowl, continuing around to the sides of the bowl and then declining in height to accommodate for easy access to the animal and optimal protection provided by the splash guard.

The base of the bowl has been designed with 4 small areas and a rim that protrude slightly from the base surface of the bowl. This allows for less area contact to the floor to limit sliding of the bowl during feeding. This being an added feature to this invention and not a mandatory feature to the function of the bowl.

The present invention pertains to a method for feeding an animal. The method is comprised of the steps of pouring feed or water in to the bowl. The inner ridge serves as a general suggested filling point. The elevated walls of the bowl serve as a barrier to prevent over spray, splashes and splatters from leaving the confines of the inside of the bowl.

The presence of the splashguard, or walls, gives added weight, which increase drag capabilities and further inhibit movement of the bowl on the ground surface.

### BRIEF DESCRIPTION OF THE SEVERAL VIEWS OF THE DRAWING

FIG. 1 is a front view of a pet feeding bowl with a splashguard.

FIG. 2 is a rear view thereof.

FIG. 3 is a left side view thereof.

FIG. 4 is a right side view thereof.

FIG. 5 is a top plan view thereof, and

FIG. 6 is a bottom plan view thereof.

### I claim the utility design for a pet feeding bowl with a splashguard as shown.

### DETAILED DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

In practice, the pet bowl with splashguard is molded out of a conventional plastic such as, and not limited to, Lexan, Acrylic, ABS or more commonly polypropylene.

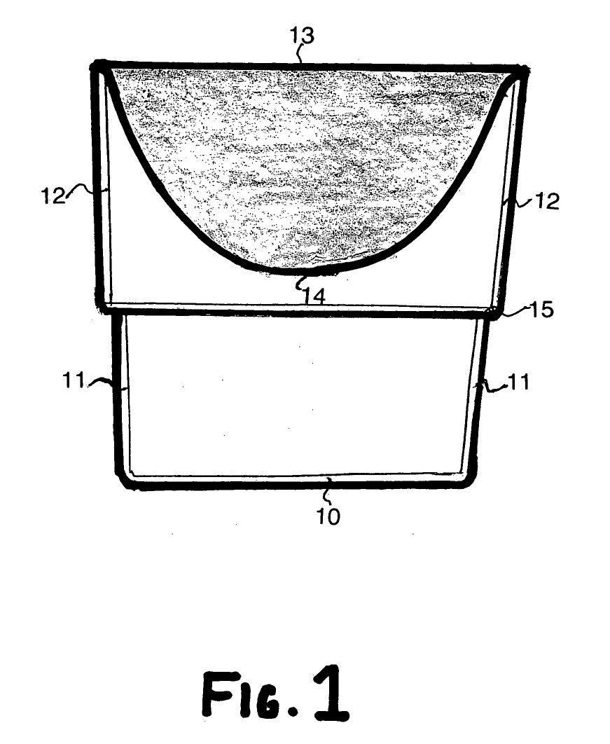

In the various views of the drawings, like reference characters designate like or similar parts throughout the several views, and more specifically to FIGS. 1-6. FIG. 1 represents a front view of the invention. Having a base 10 and an attached continuous sidewall 11 around the outside perimeter of the base 10 that comprises the main feeding area for feed or water. A second sidewall 12 represents the splashguard portion of the invention, in connection with base bowl wall portion 11 adjoining at point 15. The 2 functioning sections of the invention are distinguished also by an increase in the width of the overall unit at the top perimeter of the base bowl section of the invention to the splashguard 12 embodiment. The increase of perimeter forms a ridge that serves as both a guide for filling and allows for consistency in the weight of the bowl to prevent skidding or excessive movement of the invention while feeding. The difference of outer wall widths is not an essential portion of the invention but has been added for additional functionality of the invention.

The apex 13 is centered at the rear of the perimeter of the bowl and continues in relative height around the perimeter and then decreasing in height equally, both left and right and gradually tapering off in height, with the lowest height running along the front center 14 of the invention, about a inch above the base feeding bowl portion. The 2 functioning sections of the invention are distinguished also by an increase in the width of the overall unit at the top perimeter of the base bowl section of the invention to the splashguard 12 embodiment. The increase of perimeter forms a ridge that serves as both a guide for filling and allows for consistency in the weight of the bowl to prevent skidding or excessive movement of the invention while feeding. The difference of outer wall widths is not an essential portion of the invention but has been added for additional functionality of the invention.

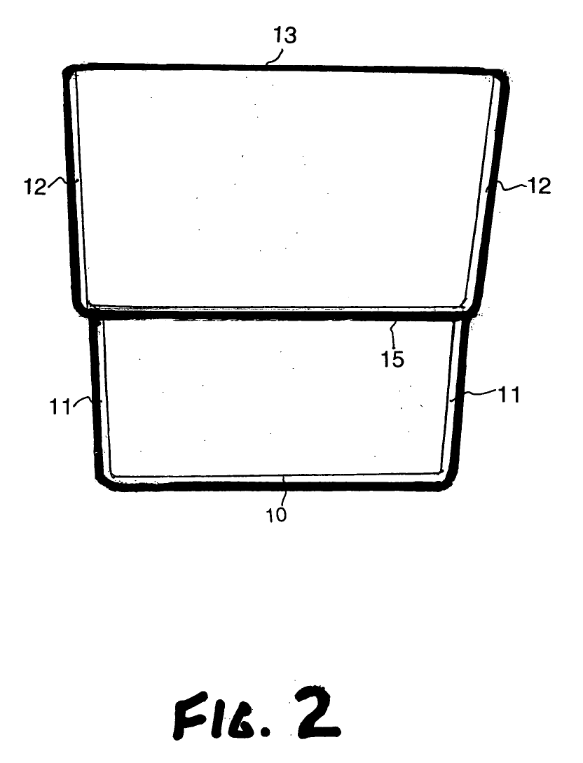

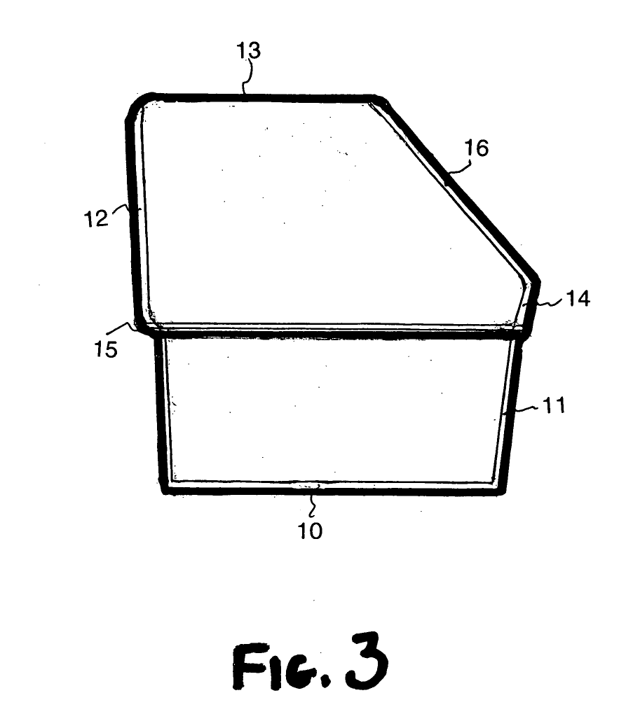

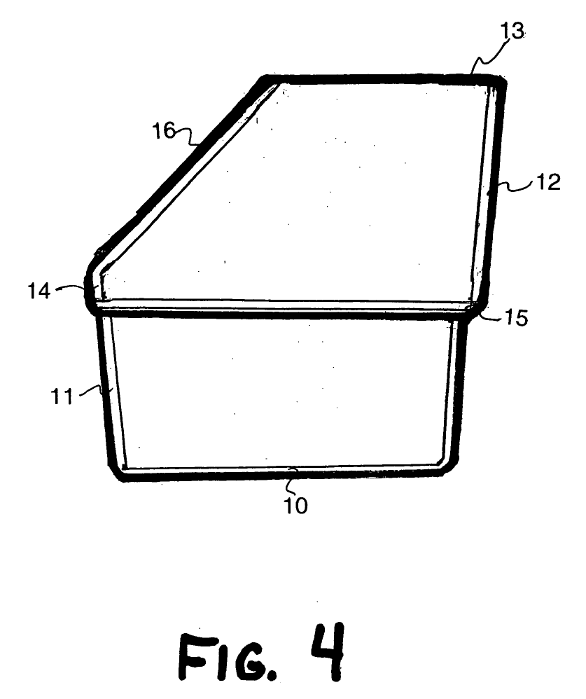

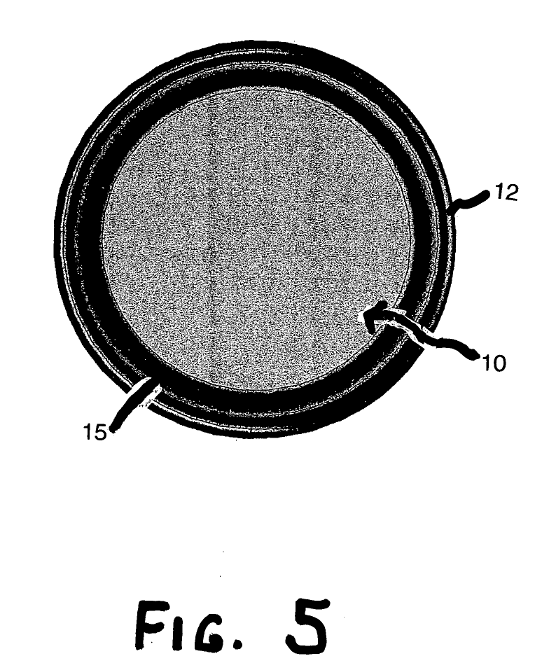

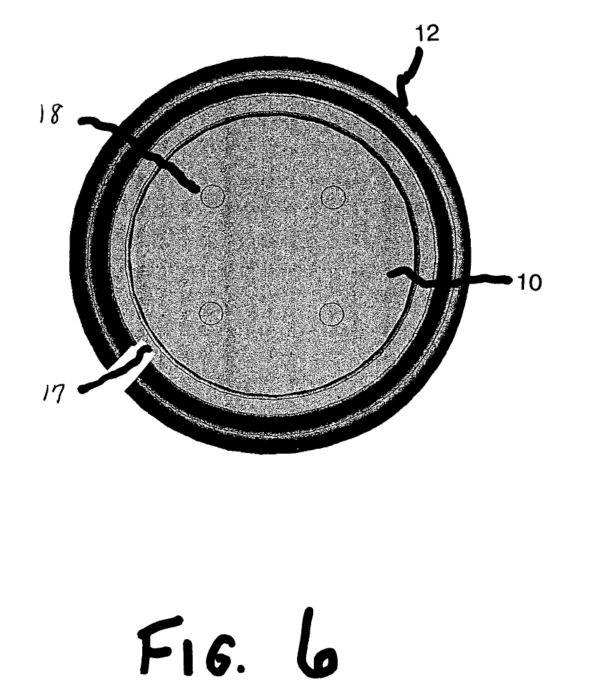

FIG. 2 represents a rear view of the invention. FIG. 2 illustrates the apex of the invention 13. The apex 13 serves the primary function of retaining over spray, splashes and splatters while a pet feeds from the invention. The combination of the outer wall 12 and height of the splashguard 13, function together to serve the purposes as claimed for this invention. FIG. 3 represents a left view of the invention for illustration of this perspective and contains the same embodiments as formerly presented. FIG. 4 represents a right view of the invention for illustration of this perspective and contains the same embodiments as formerly presented. FIG. 5 represents a top view of the invention and illustrates the same embodiments as formerly presented. FIG. 6 represents a bottom view of the invention. The bottom portion of the base 10 has been recessed a small amount to provide and outer rim 17. Four circular protrusions centered equally at the bottom of the base of the bowl 10 serves to stabilize the bowls leverage with the floor. The reduction of surface area in contact with the floor or surface area which the bowl is place, is reduced by these two features, 17 and 18. The reduction of surface-to-surface contact is intended to further reduce sliding or excessive movement of the bowl with splashguard during use.

While the present invention has been described at some length and with some particularity with respect to the several described embodiments, it is not intended that is should be limited to any such particulars or embodiments or an particular embodiment, but is to be construed with references to the appended claims so as to provide the broadest possible interpretation of such claims in view or prior art and, therefore, to effectively encompass the intended scope of the invention.

What I claim as my invention is:

1. A pet feeding bowl for placement on a surface, comprising as one unit, an injection molded product, having two sections with individual purposes: a) a base bowl section for feeding, having a bottom, an outer wall and a inner wall, and b) an attached wall that serves as the splashguard.

2. A pet feeding bowl in accordance with claim 1, wherein said base bowl serves as a feeding bowl for animals.

3. A pet feeding bowl in accordance with claim 1, where said splashguard serves to confine over spray, splashes and splatters from feeding, to the inside of the unit.

4. A method in accordance with claim 3, wherein this invention protects surfaces adjacent to the feeding area from the over spray, splashes and/or splatters that would otherwise occur from a feeding bowl without a splashguard or retention surface.
